(19) United States
(12) Patent Application Publication
(10) Pub. No.: US 2011/0271477 A1
(43) Pub. Date: Nov. 10, 2011

(54) Finger tool

(76) Inventor: Chin-Hsiung Lien, El Monte, CA (US)

(21) Appl. No.: 12/800,222

(22) Filed: May 10, 2010

(51) Int. Cl. B05C 17/10

(52) U.S. Cl. 15/245.1

(57) ABSTRACT

A finger tool, having the structure and functions simulated from human finger, includes an elongated applicator body and a skeleton support. The applicator body has an applicator portion and a handle portion. The applicator portion, which is made of deformable material for providing a predetermined elasticity, defines an inclined applicator surface inclinedly extended from the top side to the bottom side. When a pressing force is applied on the top side of the applicator body at the applicator portion thereof, the pressing force is transmitted and evenly distributed at the applicator surface for shaping and smoothing said sealant at the narrow opening. The skeleton support is provided at the handle portion for providing a rigid framework at the handle portion and maintaining a shape thereof so as to ensure the pressing force being transmitted through the applicator portion of the applicator body.

### BACKGROUND OF THE PRESENT INVENTION

1. Field of Invention

The present invention is generally related to a tool for tooling and smoothing sealants and/or adhesives, and more particularly to a finger tool having an essentially human finger simulated structure and functions for tooling and smoothing the sealant.

2. Description of Related Arts

In many constructions or assemblies, there are unavoidable clearances, such as gaps, joints, seams, or the like, which are difficult to seal the openings of the clearances. For instances, the gaps of the drywall; the seams between the ceramic tiles; and the joints between two wooden pieces are difficult to be shut by the materials. In order to seal or close those clearances, the sealants or adhesives are widely applied thereon to caulk the clearances and to prevent the penetration of water, air, any other liquids or gases, or to form the watertight or airtight structure of the objects. The sealant may be also provided for maintaining or sealing the joint between two parts.

The sealant normally is colloidal state when the sealant is contained in a container, and gradually turns to solid state after it is applied on the clearances and dried, so that the sealant has the flexibility to caulk any shapes of the tiny openings or joints. The sealant are commonly contained within a containing body of a caulking gun for further assisting the caulking, so that the sealant is able to be dispensed through a narrowing nozzle tip of the caulking gun to conveniently caulk the clearances via the sealant.

After carefully filling the clearances via the sealant, a user may have to use a tool for smoothing and/or shaping the sealant applied on the clearances, so that the sealant is able to be perfectly filled therewithin for sealing and adhering purposes. It is worth to mention that if the sealant is formed at the clearances without being smoothed by any tools, the surface of the sealant may be unevenly seated at the clearances, which is not only unsightly, but also have highly possibility that the germs or bacterial may be accumulated within the apertures on the uneven surface of the sealant.

The user may conveniently use his finger to press on the sealant applied along the clearance, so that the sealant is able to be nicely shaped and smoothed, so as to enhance the adhesiveness between the object and the sealant and to finish and embellish the construction or assembly. Shaping the sealant after applied on the clearances also ensures the sealant is perfectly fitting and filling the clearance to form the airtight, watertight, or steamtight structures, so as to minimize the leaking happened at the joints or gaps of the objects, which might not be easily closed up by the material of object itself.

Accordingly, the human finger has the muscle and the bone for supporting the muscle, so that the finger has a cushioning portion from the muscle, which is being supported by the bone for providing certain rigidness. Therefore, the manipulation of human finger as the hand tool for shaping and smoothing the sealant applied on the narrow openings has the following advantages.

The cushioning portion having the narrower fingertip part thereat is able to provide a predetermined elasticity for extendably reaching the tiny gaps, joints, or clearances of narrow openings. The elastic cushioning portion is also able for flexibly applying varies pressures on the sealant applied along the clearances of the narrow opening in a force controllable manner, so as to be deformed with respect to the geographic shape of each of the narrow openings for shaping the sealant.

Shaping the sealant with respect to the silhouette is able to further enhance the adherence between the sealant and the material of the clearances, and to ensure completely sealed the narrow openings between two objects of the material, such as two piece of wood, drywall, or concrete, and/or to fix the object on the floor or wall during a construction, such as sealing the joints between the sink and counter top. Therefore, the human finger is able to easily apply the pressing force on the sealants and flexibly being deformed to fit the shape of the clearances.

The bone of the human finger, which is a solid material, is also able to provide a frame to keep the cushioning portion supported. Therefore, the bone can generate and transfer the pressing force from the fingertip of the cushioning portion to the sealant, so that the human finger is able to be manipulated in a three dimensional manner, so as to flexibly using the finger as the hand tool for shaping sealant.

The human finger also has the hard nail portion located around the fingertip part of the finger, so that the nail of human finger can be used as a spatula for scooping, spreading, and shaping the sealant when the sealant is still in the colloidal soft state.

In addition, the fingerprint provides a certain friction thereon for smoothing the surface of the sealant, so as to assist shape the sealant in accordance to the figure of the clearances.

Accordingly, the human finger has the structure and functions which is conveniently suited for shaping and smoothing the sealant (or adhesive) surface after the sealant is filled up the clearances, gaps, joints, or seams of the narrow openings. The structure of cushioning portion being supported by the rigid bone, the fingertip part, and the frictional surface of the finger print of human finger is perfectly for being manipulated for tooling and finishing the surface of the sealant.

Though the operation of shaping and smoothing the sealant via the human finger is excellent, there are some main concerns of manipulation of human finger for smoothing and shaping the sealant. First, the sealants (or adhesives) may contain varieties of chemicals according to the applications of sealants, wherein the containing chemicals of the sealant possibly harmful to the human skin on the finger, so that using the human finger for operating the smooth and shape process of the sealant may be dangerous to human beings.

Furthermore, washing the remaining sealant on the finger of human hand could be exhausting. It may be hard to wash away the chemical compounds of the sealant when the chemicals are stained on the finger. If the user used their nails as the rigid spatulas plat for spreading and shaping the sealant, the sealant tens to deeply stuck within the nails, so that cleaning the finger after shaping or smoothing the sealant thereby is even more painful.

After applying the sealant at the narrowing openings, most of the sealants have the characteristic of becoming solid after being naturally air dried. As a result, the sealant stained on the finger of human is even harder for being removed from the finger skin.

In order to keep the finger away from the chemicals of the sealants, the current market provides the spatulas or spreader tool for shaping the sealant, which is filled up the narrow openings of the objects. Although those tools might be able to protect the human fingers, the structures of spatulas tools do not have the abilities for universally matching and reaching the narrow openings. It is inconvenient by using the current tools for tooling the sealants. The narrowing openings may be formed by two objects extended to form varieties of angles therebetween, so that the spatulas can not be satisfied for optimum of manipulation of shaping or smoothing the sealants.

Accordingly, the present invention provides a finger tool which stimulates the human finger structure and functions for maximizing the sealant performance by providing an optimum sealant shape via the finger tool.

### SUMMARY OF THE PRESENT INVENTION

The invention is advantageous in that it provides a finger tool to maximize the sealant (or adhesive) performances for sealing and adhering to the narrowing openings between substrates.

Another advantage of the present invention is to provide a finger tool, which has a human finger stimulated structure and functions for shaping and smoothing the sealant applied on the small openings, so as to provide an optimum sealant shape to enhance the caulking performance.

Another advantage of the present invention is to provide a finger tool, which is able to prevent the human finger being harmed from the chemical contains of sealant or being scratched or cut via the surface of the substrates of the narrow opening when the human finger is used for shaping or smoothing the narrow opening, while being able to tool the sealant to optimize the sealant performance.

Another advantage of the present invention is to provide a finger tool, wherein the applicator portion made of deformable material has a predetermined elasticity for providing a human finger cushioning characteristic, so that the finger tool is able to be conveniently and universally deformed to match the vary shapes of narrow openings, so as to evenly control and distribute a pressing force to the sealant.

Another advantage of the present invention is to provide a finger tool, wherein the applicator portion of the applicator body is made of material having predetermined elasticity for providing the cushioning feature thereat, so as to control the pressing force at the applicator portion with respect to the configurations of each of the clearances.

Another advantage of the present invention is to provide a finger tool, wherein the skeleton support having a predetermined rigidness is able to provide a framework to keep the handle portion supported. Therefore, the applicator portion may transfer the pressing force from the applicator surface to the sealant, so as for conveniently manipulating the finger tool.

Another advantage of the present invention is to provide a finger tool, wherein a shaping plate is provided at the applicator body at a position slightly protruding out of the tip end thereof, which is able to simulate the features of human finger nails, so that finger tool is able to cut, scrape, or spreading the sealant by the shaping plate for further shaping thereof.

Another advantage of the present invention is to provide a finger tool, wherein a coarse surface is formed at the applicator surface for simulating the features of finger print, so that the finger tool is able to provide a predetermined friction thereon for smoothing the sealant.

Another advantage of the present invention is to provide a finger tool, wherein the applicator portion of tool holder is made of absorbent material, so that the finger tool is washable for cleaning purpose.

Another advantage of the present invention is to provide a finger tool, wherein the puncturing element is able to be removed from the applicator body to dispose one pointed end having a sharpen tip thereat in the environment, so that the puncturing element can further be used as a tool for penetratingly into an opening of a caulking gun, which dispensing the sealant therefrom.

Additional advantages and features of the invention will become apparent from the description which follows, and may be realized by means of the instrumentalities and combinations particular point out in the appended claims.

According to the present invention, the foregoing and other objects and advantages are attained by providing a finger tool for shaping and smoothing a sealant applied along narrow openings, wherein the finger tool has structure and functions for simulating human finger.

The finger tool comprises an elongated applicator body with a finger size, having an applicator portion defining at a front end thereof and a handle portion rearwardly extending form the applicator portion for being held by a user hand. The applicator body further has a top side and a bottom side. The applicator portion, which is made of deformable material for providing a predetermined elasticity at the applicator portion, defines an inclined applicator surface inclinedly extended from the top side to the bottom side. Therefore, when a pressing force is applied on the top side of the applicator body at the applicator portion thereof, the pressing force is transmitted and evenly distributed at the applicator surface for shaping and smoothing said sealant at the narrow opening.

The finger tool further comprises a skeleton support provided at the handle portion of the applicator body for providing a rigid framework at the handle portion and maintaining a shape thereof so as to ensure the pressing force being transmitted through the applicator portion of the applicator body.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a finger tool according to a preferred embodiment of the present invention.

FIG. 2 is a schematic view of the finger tool according to the preferred embodiment of the present invention, illustrating the operation of the finger tool.

FIG. 3 is side sectional views of the finger tool according to the preferred embodiment of the present invention.

FIG. 4 is a perspective view of the finger tool according to the preferred embodiment of the present invention, illustrating a shaping plate coupled with the applicator body.

FIG. 5 illustrates an alternative mode of the applicator body of the finger tool according to the preferred embodiment of the present invention.

### DETAILED DESCRIPTION OF THE PREFERRED EMBODIMENT

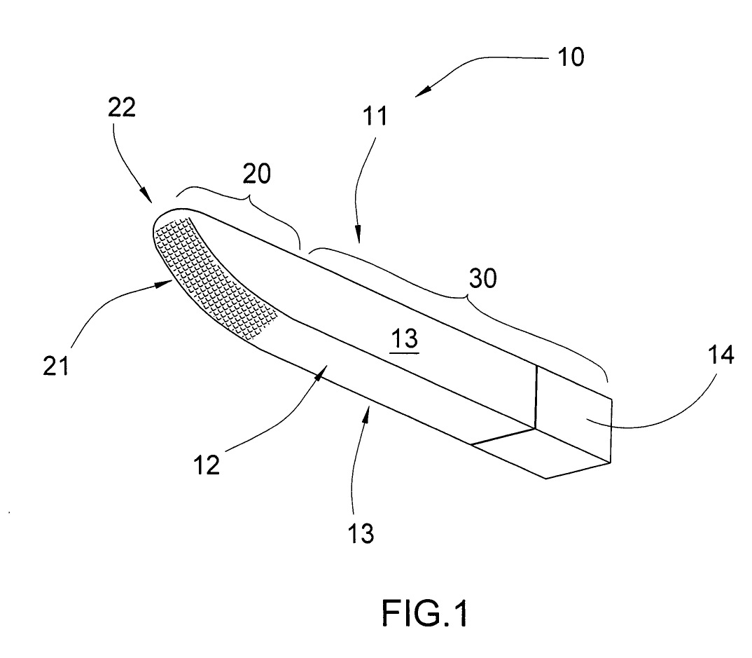

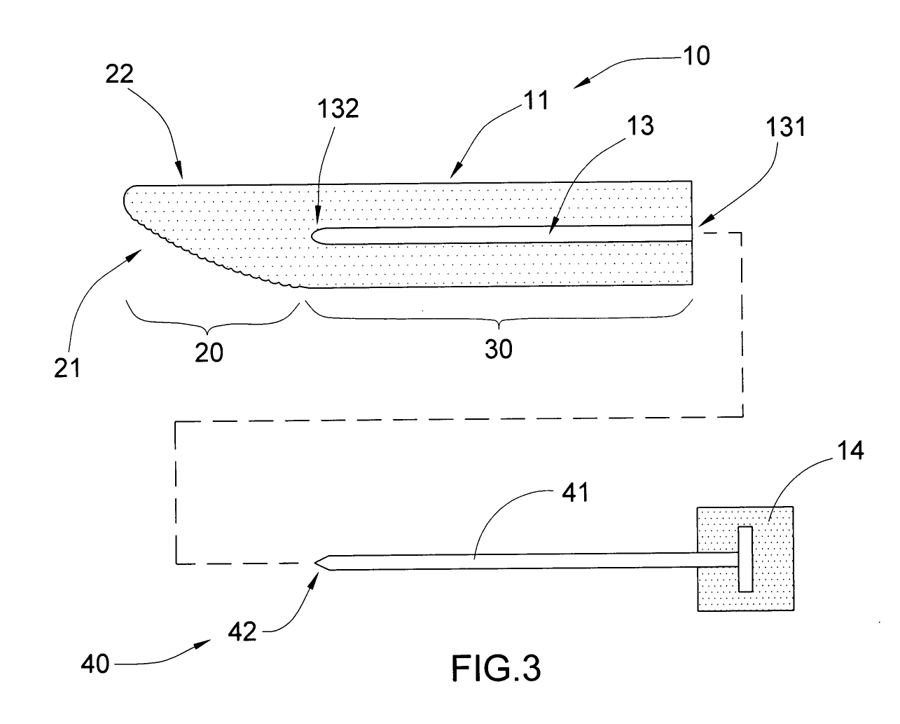

Referring to FIGS. 1 and 3 of the drawings, a finger tool according to a preferred embodiment of the present invention is illustrated, wherein the finger tool has a human finger simulated structure and functions for tooling sealants (or adhesives) applied on narrowing openings, such as gaps, seams between drywall or concrete, or joints between to substrates.

In other words, tooling the sealant by using the finger tool is able to shape and smooth the sealant or the likes, and to optimize the configurations of the sealants, so as to maximize the performance of the sealant. Therefore, the tooling the sealants after the sealant being applied along the narrow openings is able to enhance the sealing feature to perform airtight, watertight, or the likes, and adherence performance of the sealant.

According to the preferred embodiment, the finger tool comprises an elongated applicator body 10 with a finger size, and a skeleton support 40 for providing a predetermined rigidity.

The applicator body 10 has an applicator portion 20 defining at a front end thereof and a handle portion 30 rearwardly extending form the applicator portion 20 for being held by a user hand. The applicator body 10 further has a top side 11 and a bottom side 12, wherein the top side 11 of the applicator body 10 is adapted for a finger, preferably an index finger, of the user to press thereon. In addition, a width of the top side 11 is about the size of the finger of the user.

The applicator portion 20, which is made of deformable material for providing a predetermined elasticity at the applicator portion 20, defines an inclined applicator surface 21 inclinedly extended from the top side 11 to the bottom side 12 and arranged in such a manner that when a pressing force is applied on the top side of the applicator body at the applicator portion 20 thereof, the pressing force is transmitted and evenly distributed at the applicator surface 21 for shaping and smoothing the sealant at the narrow opening.

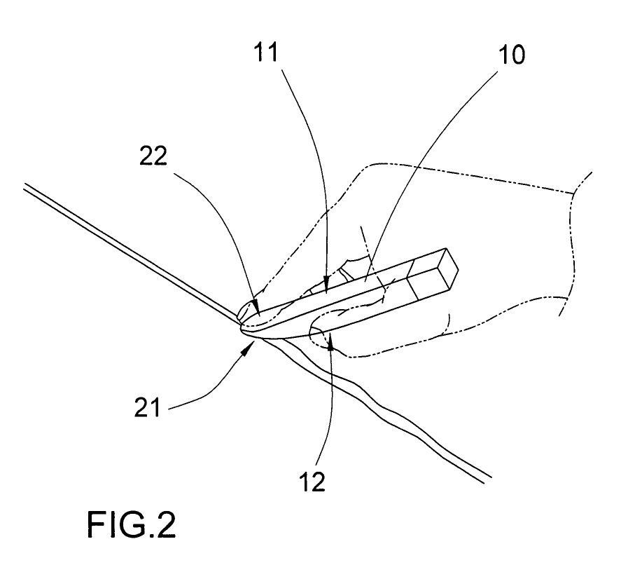

As shown in FIGS. 1 and 3, the applicator surface 21 is downwardly and rearwardly extended from the top side 11 of the applicator body 10 to the bottom side 12 thereof to define a top pressuring surface 22 at the top side 11 of the applicator portion 20 for a tip segment of a finger resting on the pressuring surface 22. As shown in FIG. 2, the tip segment of the index finger is arranged for pressing at the pressuring surface 22 such that the pressing force at the pressuring surface 22 is transmitted to the applicator surface 21 through the applicator portion 20 of the applicator body 10.

In addition, the applicator surface 21 is a coarse surface for providing a predetermined friction when the applicator surface 21 contacts with the sealant. The applicator surface 21 is able to provide a predetermined friction between the applicator surface 21 and the surface of sealants for optimizing the operation of the smoothing and shaping the sealants, so as to simulate the finger print of human finger for smoothing the sealant.

Therefore, the applicator portion 20 of the applicator body 10 is corporatively and deformably shaping and smoothing the sealants with respect to the configurations of the vary narrow openings, as if using a cushioning human fingertip to tool the sealants. It should be noted that the deformable applicator surface 21 is able to guide the applicator portion 20 to be elastically deformed in accordance with the configurations of the narrow openings, so as to easily and conveniently shape the sealant with respect to the configuration of the gaps, seams, joints, or the likes.

The skeleton support 40 is provided at the handle portion 30 of the applicator body 10 for providing a rigid framework at the handle portion 30 and maintaining a shape thereof so as to ensure the pressing force being transmitted through the applicator portion 20 of the applicator body 10.

According to the preferred embodiment, the applicator body 10 is made of foaming material having absorbent ability. Alternatively, the applicator body 10 can be made of elastic material, such as rubber, or sponge.

The handle portion 20 of the applicator body 10 preferably has a quadrilateral cross section and defines two sidewalls 13 adapted for a thumb and middle finger gripping thereat respectively so as to ensure an index finger being aligned and rested on the top side 11 of the applicator body 10. Accordingly, the top side 11 of the applicator body 10 should be long enough for the finger to rest thereon at a position that the tip segment of the index finger is arranged for pressing at the pressuring surface 22 of the applicator portion 20 so as to stimulate a human fingertip for reaching the narrow openings, as shown in FIG. 2.

According to the preferred embodiment, the skeleton support 40 comprises a pin-shaped puncturing element 41 having a shape tip 42 and being detachably embedded within the handle portion 30 of the applicator body 10.

As shown in FIG. 3, the applicator body 10 further has an elongated receiving channel 13 provided at the handle portion 30 of the applicator body 10 for slidably receiving the puncturing element 41 of the skeleton support 40 thereat. The receiving channel 13 has an opened end 131 formed at a rear side of the handle portion 30 and a closed end 132 provided at the handle portion 30 close to the applicator portion 20 to receive the shape tip 42 of the puncturing element 41 at the closed end 132 so as to block the shape tip 42 of the puncturing element 41 extending to the applicator portion 20. In other words, the receiving channel 13 is extended through the handle portion 30 of the applicator body 10 and is stopped at the applicator portion 20 such that the puncturing element 41 will not extended to the applicator portion 20 of the applicator body 10.

A length of the puncturing element 41 is longer than a length of the receiving channel 13, such that when the puncturing element 41 is slid into the receiving channel 13, a tail portion of the puncturing element 41 is outwardly protruded from the rear side of the handle portion 30 at the opened end 131 of the receiving channel 13.

Accordingly, the puncturing element 41 is able to keep the deformable handle portion 30 supported. Therefore, the puncturing element 41 is also formed with the handle portion 30 for being conveniently held for applying the pressing force through the applicator portion 20, such that the puncturing element 41 will not provide any rigidity at the applicator portion 20 for preventing the pressing force transmitting to the applicator surface 21. In other words, the puncturing element 41 forms as if a human finger bone embedded in finger muscle for supporting thereof, so as to tool the sealants to an optimum shape.

It is worth to mention that a dispensing tip of a caulking tool for dispensing the sealants out of the caulking tool and applying it to the narrow openings, such as a caulking gun, tends to be clogged due to the sealant gradually dried and became hardened at the dispensing tip after contacting with air. The shape tip 42 of the puncturing element 41 is able to be slidably removed from the handle portion 30 of the applicator body 10, so that a user is able to apply a force at the puncturing element 41 to penetrate the sharp tip 42 into the dispensing tip of the caulking tool, so as to provide another function of the finger tool for opening the dispensing tip of the caulking tool.

In other words, the tail portion of the puncturing element 41 is protruded out of the receiving channel 13, so that the puncturing element 41 is able to be conveniently slid out of the receiving channel 13 for being used as another functional tool thereof In the preferred embodiment of the present invention, the applicator body 10 may further comprises a cover head 14 coupled at the tail portion of the elongated body for covering the tail portion of the puncturing element 41, such that the puncturing element 41 is embedded within the applicator body 10 at the handle portion 20 thereof. Therefore, the puncturing element 41 is able to be slidably removed for being used as penetrating tool to open the dispensing tip of the caulking tool.

It is worth to mention that the head cover 14 embedding the tail portion of the puncturing element 41 is able to prevent the puncturing element 41 being accidentally and harmfully slid out of the receiving channel 13, so as to enhance the safety of the finger tool.

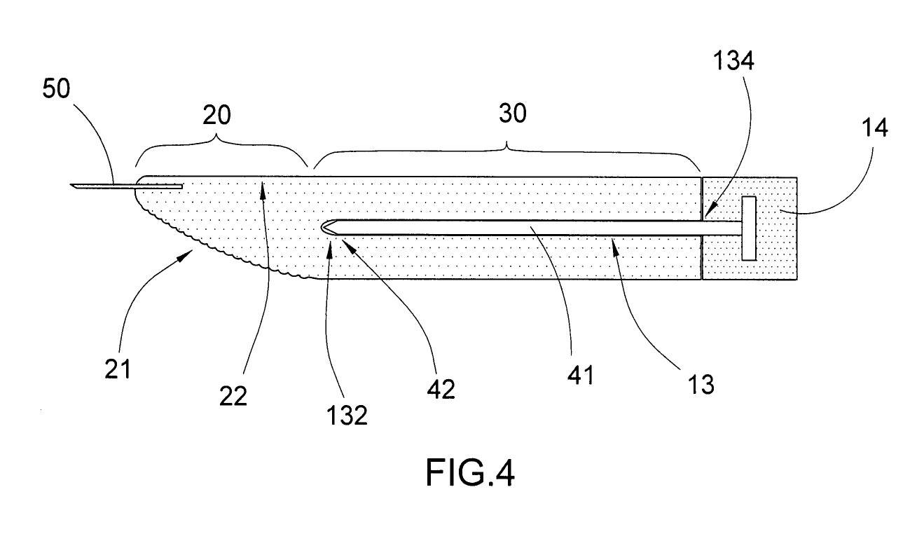

As shown in FIG. 4 of the drawings, the finger tool of the present invention is modified that the finger tool further comprises a shaping plate 50 frontwardly extended from the top side 11 of the applicator body 10, wherein the shaping plate 50 has a predetermined rigidness for shaping said sealants at the narrow openings. Accordingly, the shaping plate 50 is frontwardly extended from the front tip of the applicator body 10, wherein the shaping plate is suitable to be used for further tooling the sealants, such as cutting, scraping, spreading sealants, or the likes. In other words, the shaping plate 50 is preferred to be simulated for working as a nail of human finger for further providing multi functions of the finger tool.

Accordingly, the finger tool has the deformable applicator portion 20 for simulating the cushioning muscle of human finger and the skeleton support 40 for simulating the bone frame of human finger and to support the operation of the applicator portion 20 for elastically manipulating the applicator 20 deformably reaching the narrow opening to shape the sealant.

Therefore, the finger tool simulated the structure and functions of human fingers is able to conveniently shape and smooth the sealants to an optimum configuration for enhancing performances of sealing and adherence the narrow opening via the sealant. Meanwhile, the finger tool is able to avoid the directly contact between the sealant and the skin of human finger, so as to prevent the chemical ingredients of the sealant being harmful to the human skin, as shown in FIG. 2.

As mention above, the applicator portion 20 of the finger tool may be also made of an absorbent material, such as the foaming material having open cells thereon, rubber material, or other polymer material, so that applicator portion 20 directly contacting with the sealants is able to be rewashed to keep it clean. Therefore, the washable applicator body 10 is able to be removed for cleaning purpose, so as to maintain the performance of the finger tool.

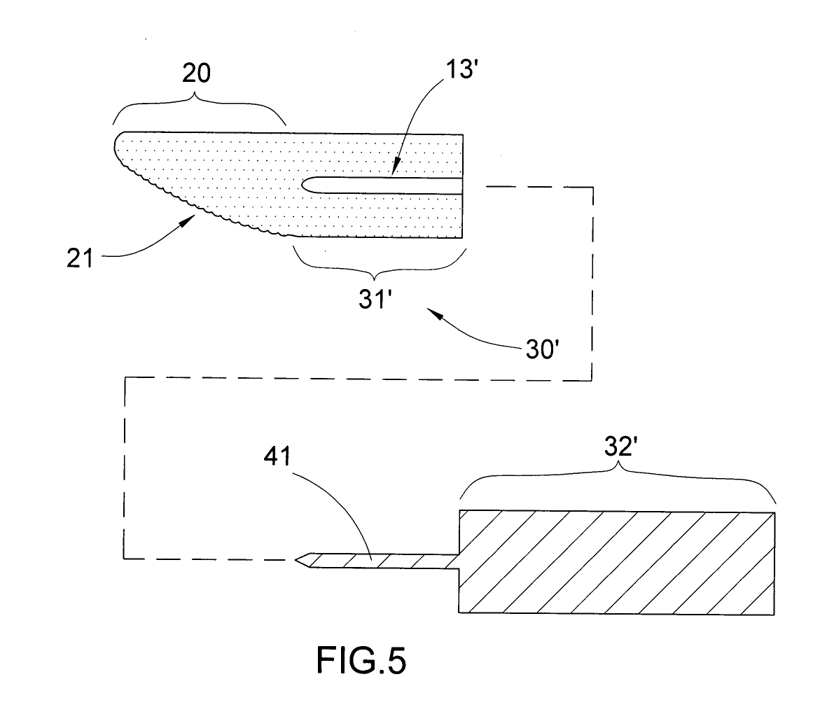

FIG. 5 illustrates an alternative mode of the applicator body 10′, wherein the handle portion 30′ has a front portion 31′ integrally extended from the applicator portion 20 and defining the receiving channel 13′ within the front portion 31′, and a rear portion 32′ detachably coupled with the front portion 31′.

As shown in FIG. 5, the puncturing element 41 is frontwardly extended from the front wall of the rear portion 32′ of the handle portion 30′ and is sildably and detachably received within the receiving channel 13′. In other words, when the puncturing element 41 is slid into the receiving channel 13′, the rear portion 32′ is coupled with the front portion 31′ to form an elongated structure of the handle portion 30′.

It is worth mentioning that the front portion 31′ of the handle portion 30′ is made of deformable material as the applicator portion 20 because the front portion 31′ is integrated with the applicator portion 20. The rear portion 32′ of the handle portion 30′ can be made of other materials, such as durable material such as plastic or metal that the puncturing element 41 can be integrated with the rear portion 32′ of the handle portion 30′ to form a one-piece configuration.

Accordingly, the finger tool is simulated the elongated shape of the human finger, and has the deformable front tip end and the applicator portion 20 for providing the cushioning and deformable fingertip feature of human finger, such that the finger tool is able to deformably reach and match the vary configurations of narrow opening where the sealant is applied therealong.

More over, the applicator surface 21 inclinedly formed at the front tip end of the applicator portion 20, so that applicator surface 21 is able to elastically guide the tip end to conveniently reach the sealant at the narrow openings. The elongated handle portion 30 is able to be held for controllably applying the pressing force at the deformable applicator portion 20 in the force controllable manner.

Take a gap of narrow opening between the drywall and the shower top for example. The vertically standing drywall and the shower top may form a 90° narrow opening therebetween, wherein after the sealant being dispensed along the narrow opening, the finger tool is read to shape and smooth the sealant before the sealant being naturally dried. The applicator portion 20 may bias against a top edge surface of the shower to deformably guide the applicator surface 21 fittingly contacting with the surface of sealant and controllably applying the pressing force with respect to the configuration of 90° narrow opening, so that the sealant is able to be shaped perfectly along the narrow opening for maximizing the sealing or watertight purpose of the sealant, as illustrated in FIG. 2.

It should be noted using human finger for tooling, such as shaping, may also hurt the human finger by the saw dust on the wooden substrates of narrow opening. Therefore, using the finger tool is able to avoid the human finger being hurt by the roughly surface of the substrates. The applicator surface 21 of the finger tool also allows the applicator portion 20 to conveniently clean out the saw duct by the friction of the applicator surface 21.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A finger tool having a human finger simulated structure and functions for tooling sealants applied on narrow openings, comprising:
an elongated applicator body with a finger size, having an applicator portion defining at a front end thereof and a handle portion rearwardly extending form said applicator portion for being held by a user hand, wherein said applicator body further has a top side and a bottom side, wherein said applicator portion, which is made of deformable material for providing a predetermined elasticity at said applicator portion, defines an inclined applicator surface inclinedly extended from said top side to said bottom side and arranged in such a manner that when a pressing force is applied on said top side of said applicator body at said applicator portion thereof, said pressing force is transmitted and evenly distributed at said applicator surface for shaping and smoothing said sealant at said narrow opening; and
a skeleton support provided at said handle portion of said applicator body for providing a rigid framework at said handle portion and maintaining a shape thereof so as to ensure said pressing force being transmitted through said applicator portion of said applicator body.

2. The finger tool, as recited in claim 1, wherein said applicator surface is downwardly and rearwardly extended from said top side of said applicator body to said bottom side thereof to define a top pressuring surface at said top side of said applicator portion for a tip segment of a finger resting on said pressuring surface.

3. The finger tool, as recited in claim 1, wherein said skeleton support comprises a pin-shaped puncturing element having a shape tip and being detachably embedded within said handle portion of said applicator body.

4. The finger tool, as recited in claim 2, wherein said skeleton support comprises a pin-shaped puncturing element having a shape tip and being detachably embedded within said handle portion of said applicator body.

5. The finger tool, as recited in claim 3, wherein said applicator body further has an elongated receiving channel, which is provided at said handle portion of said applicator body, having an opened end formed at a rear side of said handle portion and a closed end provided at said handle portion close to said applicator portion to receive said shape tip of said puncturing element at said closed end so as to block said shape tip of said puncturing element extending to said applicator portion.

6. The finger tool, as recited in claim 4, wherein said applicator body further has an elongated receiving channel, which is provided at said handle portion of said applicator body, having an opened end formed at a rear side of said handle portion and a closed end provided at said handle portion close to said applicator portion to receive said shape tip of said puncturing element at said closed end so as to block said shape tip of said puncturing element extending to said applicator portion.

7. The finger tool, as recited in claim 5, wherein a length of said puncturing element is longer than a length of said receiving channel, such that when said puncturing element is slid into said receiving channel, a tail portion of said puncturing element is outwardly protruded from said rear side of said handle portion at said opened end of said receiving channel.

8. The finger tool, as recited in claim 6, wherein a length of said puncturing element is longer than a length of said receiving channel, such that when said puncturing element is slid into said receiving channel, a tail portion of said puncturing element is outwardly protruded from said rear side of said handle portion at said opened end of said receiving channel.

9. The finger tool, as recited in claim 1, wherein said handle portion of said applicator body has a quadrilateral cross section and defines two sidewalls adapted for being gripped tightly so as to ensure a finger of the user being aligned and rested on said top side of said applicator body.

10. The finger tool, as recited in claim 4, wherein said handle portion of said applicator body has a quadrilateral cross section and defines two sidewalls adapted for being gripped tightly so as to ensure a finger of the user being aligned and rested on said top side of said applicator body.

11. The finger tool, as recited in claim 8, wherein said handle portion of said applicator body has a quadrilateral cross section and defines two sidewalls adapted for being gripped tightly so as to ensure a finger of the user being aligned and rested on said top side of said applicator body.

12. The finger tool, as recited in claim 1, wherein said applicator surface is a coarse surface for providing a predetermined friction when said applicator surface contacts with said sealant.

13. The finger tool, as recited in claim 4, wherein said applicator surface is a coarse surface for providing a predetermined friction when said applicator surface contacts with said sealant.

14. The finger tool, as recited in claim 11, wherein said applicator surface is a coarse surface for providing a predetermined friction when said applicator surface contacts with said sealant.

15. The finger tool, as recited in claim 1, wherein said applicator portion is made of foaming material.

16. The finger tool, as recited in claim 14, wherein said applicator portion is made of foaming material.

17. The finger tool, as recited in claim 1, further comprising a shaping plate fronwardly extended from said top side of said applicator body, wherein said shaping plate has a predetermined rigidness for shaping said sealants at said narrow openings.

18. The finger tool, as recited in claim 16, further comprising a shaping plate fronwardly extended from said top side of said applicator body, wherein said shaping plate has a predetermined rigidness for shaping said sealants at said narrow openings.

19. A finger tool for tooling sealants applied on narrow openings, comprising:
an elongated applicator body made of elastic material, having an applicator portion defining at a front end thereof and a handle portion rearwardly extending form said applicator portion, wherein said applicator body further has a top side and a bottom side, wherein said handle portion of said applicator body has a quadrilateral cross section and defines two sidewalls adapted for a thumb and middle finger gripping thereat respectively for enabling an index finger being aligned and rested on said top side of said applicator body at a position that a tip segment of an index finger rests on said top side of said applicator body at said applicator portion thereof, wherein said applicator portion defines an inclined applicator surface inclinedly extended from said top side to said bottom side and arranged in such a manner that when a pressing force is applied on said top side of said applicator body at said applicator portion thereof, said pressing force is transmitted and evenly distributed at said applicator surface for shaping and smoothing said sealant at said narrow opening, wherein said applicator body further has an elongated receiving channel provided at said handle portion of said applicator body, wherein said receiving channel has an opened end formed at a rear side of said handle portion and a closed end provided at said handle portion close to said applicator portion; and
a skeleton support provided at said handle portion of said applicator body, wherein said skeleton support has a shape tip and is detachably and slidably received at said receiving channel of said handle portion of said applicator body for providing a rigid framework at said handle portion and maintaining a shape thereof so as to ensure said pressing force being transmitted through said applicator portion of said applicator body.

20. The finger tool, as recited in claim 19, wherein said applicator body is made of foaming material having absorbent ability.
